(19) United States
(12) Patent Application Publication
(10) Pub. No.: US 2008/0291483 A1
(43) Pub. Date: Nov. 27, 2008

(54) Method for Obtaining Status, Printer Driver and Information Processing Device

(76) Inventor: Takayuki Shimatani, Tokyo (JP)

Correspondence Address: COOPER & DUNHAM, LLP, 1185 AVENUE OF THE AMERICAS, NEW YORK, NY, 10036, US

(21) Appl. No.: 10/578,232

(22) PCT Filed: Sep. 6, 2005
(86) PCT No.: PCT/JP05/16688

§ 371 Date: May 3, 2006

(30) Foreign Application Priority Data
Sep. 7, 2004 (JP) 2004-259105

(51) Int. Cl. G06F 3/12; G06F 15/00

(52) U.S. Cl. 358/1.15; 358/1.13

(57) ABSTRACT

A method for obtaining a status is disclosed in which a server computer and a client computer connected to a network share a printer connected to the server computer, and the client computer enables two-way communication and obtains status information of the printer via the server computer without depending on an operating system.

### TECHNICAL FIELD

The present invention relates to a method for obtaining status, a printer driver and an information processing device, and more specifically, a method for obtaining a status which is efficiently applied to a case where a plurality of computers share a printer, a printer driver and an information processing device.

### BACKGROUND ART

Presently, as a system for sharing one or more printers by a plurality of computers connected to a network, it is normal to use either a configuration where a print server is provided for an exclusive use or a configuration where a sharing system is embedded in the operating system of the computer.

In the former configuration of the print server, the computers connected to the network become clients. The clients perform a two-way communication with a print server so as to make reference to status information of printers, retained in the print server.

In such a configuration, for example, as described in Patent Document 1, the print server includes the following means:

status information monitoring means wherein the print server monitors a configuration and an operating state of the printers, and obtains the status information of the configuration and the operating state of the printers;
status information outputting means wherein the print server selects a computer to be notified of the status information and outputs the information to the computer with reference to a database storing the status information and information on the computer to be notified, and to a database for storing the status information;
status information showing means wherein the print server obtains the status information from the database storing the status information and shows the information; and
server communication means wherein the print server transmits the status information to the clients via the network communication line.

The clients include the following means:

client communication means wherein the client receives status information from a print server via a network communication line;
a database storing the status information obtained by the client communication means; and
status information showing means wherein the client obtains the status information from the database for storing the status information and shows the information so that the client also can obtain the status information of the printer.

### [Patent Document 1] JPA Publication No. 11-39110

Further, a configuration wherein one of a plurality of computers connected to a printer is a server, and the rest of the computers are clients, as described in Patent Document 2, includes the following steps of:

obtaining a printer status; and
writing the status obtained in the previous step in a common storage area of the server computer, which can be referred to by the client computer. The client computers make reference to the status information written in the common storage area of the server computer.

### [Patent Document 2] JPA Publication No. 2001-75754

Moreover, as for another system regarding communications between the server and the client, as described in Patent Document 3, a communication system in which a server and a client perform communications using a communication line includes the following means: communication status controlling means provided in the server, in which a communication request signal is sent to the client via a first communication line used as a two-way communication line enabling data communication between the server and the client by a request made by the server or the client so as to enable communication with the client via the communication line; and communication status controlling means provided in the client, in which the client enables communication with the server via the first communication line when the client receives a communication request signal from the server via the first communication line, and the client cancels the state, and then, the client makes a call to a predetermined repeating installation via a second communication line used as a one-way communication line enabling data communication with the server by a request which the client itself makes so as to enable communication with the server again via the communication line, the repeating installation, and a third communication line used as a one-way communication line.

### [Patent Document 3] JPA Publication No. 2004-215233

Furthermore, as described in Patent Document 4, a printer sharing network system in which a plurality of networks are connected, the networks including a plurality of work stations on which different kinds of network operating system are respectively mounted, and a printer to be shared and used by the respective work stations, includes a printer status management device managing a status of the printer of each network which is different according to the respective operating systems.

### [Patent Document 4] JPA Publication No. 8-221234

However, as described in the above Patent Document 1, in the configuration in which a print server for exclusive use is used to share one or more printers by a plurality of computers connected to the network, a configuration in which a client computer makes reference to status information is simple. However, a print server for exclusive use costs a lot, and flexibility of the configuration is reduced.

Moreover, as described above Patent Document 2, in the configuration in which one of a plurality of computers is used as a server, and other computers are used as clients, when the clients make reference to status information stored in the common area of the server, the configuration becomes intricate. In addition to this, it is a problem that the configuration cannot deal with a case where an operating system (hereinafter, referred to as OS) of the client denies two-way communication.

According to a fact that the inventor confirmed, in the configuration in which a computer mounting an operating system which as presently operating is used as a client, and a computer mounting the same or another operating system is used as a server, even if the client tries to obtain status information of a printer connected to the server, the client cannot obtain the status information of the printer since two-way communication is denied.

The invention as described in Patent Documents 3 and 4, does not suggest a solution of the problem in which the configuration cannot deal with the case where the OS of the client denies two-way communication.

### DISCLOSURE OF THE INVENTION

The present invention is being made in consideration of the above described problems, and it is a general object of the present invention to provide a method for obtaining a status of a printer by a simple configuration, a printer driver, and an information processing device.

To eliminate the above described problems, the present invention provides a method for obtaining a status, in which a server computer and a client computer connected to a network share a printer connected to the server computer, and the client computer enables two-way communication and obtains status information of the printer via the server computer without depending on an operating system.

A printer driver regarding the present invention is provided which is applicable to a system in which a server computer and a client computer connected to a network share a printer connected to the server computer, includes means to obtain status information of the printer by performing two-way communication with the server computer without depending on an operating system of the client computer.

It is preferable that the printer driver further include means to perform two-way communication by using a language monitor of the server computer as a server, and means to cause the two-way communication means to perform the two-way communication without depending on an operating system.

An information processing device regarding the present invention, which is applicable to a system in which a server computer and a client computer connected to a network share a printer connected to the server computer, includes means to obtain status information of the printer by performing two-way communication with the server computer without depending on an operating system of the information processing device.

It is preferable that the information processing device further include means to perform two-way communication by using a language monitor of the server computer as a server, and means to cause the two-way communication means to perform the two-way communication without depending on an operating system of the information processing device.

The status information to be obtained by the method for obtaining status, by the printer driver and by the information processing device, is at least one of option information indicating whether a mountable option is mounted on the printer or not, version information regarding a version of the printer, and status displaying information regarding a status of the printer.

According to the method for obtaining the status, the printer driver, and the information processing device regarding the present invention, when a server computer and a client computer share a printer via a network, the client computer obtains status information of the printer by performing two-way communication with the server computer without depending on the operating system of the client computer. Accordingly, with a simple configuration, the client computer can obtain the status information of the printer, even if two-way communication is denied by the operating system.

### BRIEF DESCRIPTION OF THE DRAWINGS

FIG. 1 is a diagram showing an embodiment of the present invention;

FIG. 2 is a block diagram functionally showing a part regarding a print operation according to the present embodiment;

FIG. 3 is a diagram showing an example of a printer which includes an ink jet recording device mounting an option;

FIG. 4 is an explanatory diagram showing an example in which status information of a printer cannot be obtained because of a difference of OS between a server PC and a client PC;

FIG. 5 is a flowchart showing an example of a two-way communication flag setting operation by a printer driver;

FIG. 6 is a flowchart showing an example of a two-way communication executing operation by the printer driver; and

FIG. 7 is an explanatory diagram showing an example in which status information of the printer can be obtained regardless of the difference of OS between the server PC and the client PC.

### BEST MODE FOR CARRYING OUT THE INVENTION

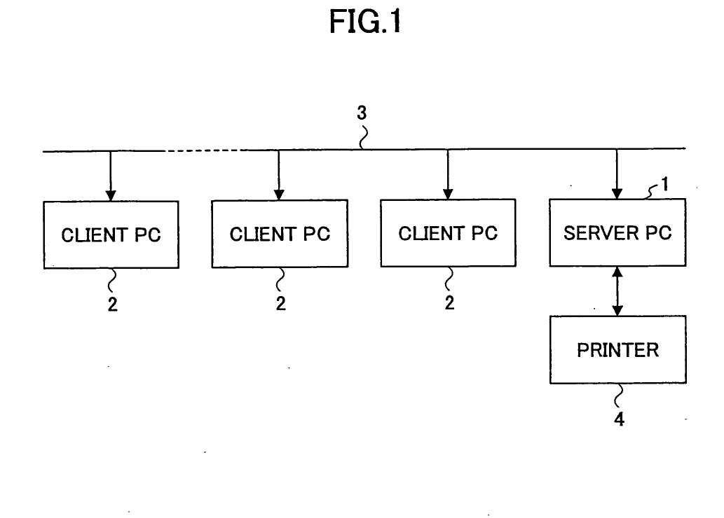

A description is given of an embodiment of the present invention with reference to accompanying drawings. FIG. 1 is a diagram showing an embodiment of the present invention.

The system includes a server computer 1 (hereinafter, referred to as Server PC 1), a plurality of client computers 2 (hereinafter, referred to as Client PC 2), a network 3 connecting Server PC 1 and Client PC 2, and a printer 4 connected to Server PC 1. Server PC 1 and Client PC 2 share the printer 4 by a sharing function of the OS.

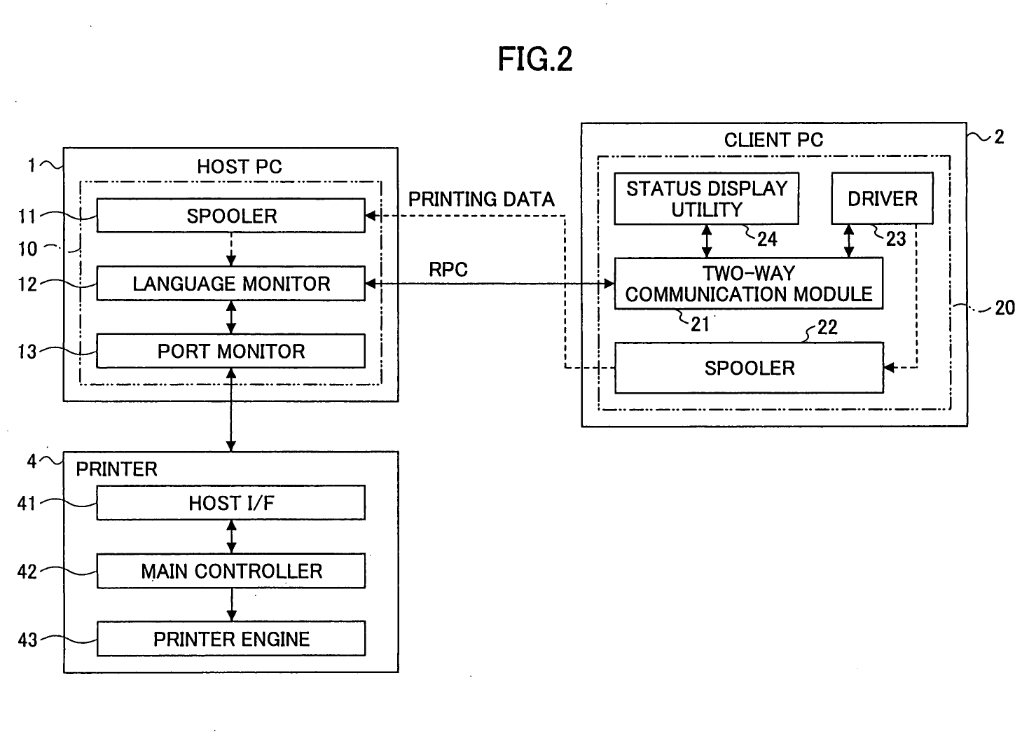

Next, with reference to FIG. 2, a description is given of a printer driver which is associated with the Server PC 1 and the Client PC 2.

First, the printer 4 includes a host interface 41 exchanging the data and the status information with a host computer i.e. Server PC 1, a main controller 42 which prints out the print data by running and controlling a printer engine 43 based on the print data received from Server PC 1 and controls Server PC 1 for outputting the print data via the host interface 41, and the printer engine 43.

The status information of the printer 4 includes option information, version information of the hardware, and status showing information. The option information includes information regarding whether a perfecting unit is mounted and information regarding whether an expansion supply cassette (or supply tray) is mounted. The status showing information includes information showing printing state, information showing running out of ink, and information showing running out of paper.

Moreover, a printer driver 10 of Server PC 1 includes a spooler 11 generating print data from the data produced by application software wherein the drawing is omitted, a language monitor 12 carrying out processing such as converting the print data received from the spooler 11 into a language for the printer 4, and a port monitor 13 outputting the data from the language monitor 12 to an actual port and reporting the status information obtained from the printer 4 to the language monitor 12. It should be noted that the printer driver of this Server PC 1 is composed of software including a printer driver in the narrow sense (hereinafter, referred to as Driver in the present description) wherein a drawing is omitted, a spooler, a language monitor, and a port monitor.

A printer driver 20 of Client PC 2 includes a two-way communication module 21 performing two-way communication with the language monitor 12 of Server PC 1, a spooler 22 generating print data from the data produced by application software where a drawing is omitted, a driver 23 making the two-way communication module 21 perform two-way communication and transmitting the data produced by application software where a drawing is omitted, and a status display utility 24 displaying the status information of the printer 4 received by the two-way communication module 21. The printer driver of Client PC 2 includes the two-way communication module 21, the spooler 22, the driver 23, and the status display utility 24.

Here, the two-way communication module 21 of Client PC 2 regards the language monitor 12 of Server PC 1 as a server for the remote procedure call (RPC). The two-way communication module 21 performs two-way communication by making an inquiry using RPC so as to obtain the status information received by the language monitor 12 of Server PC 1 from the port monitor 13.

It should be noted that the printer driver 10 of Server PC 1 and the printer driver 20 of the Client PC 2 are shown in the different diagrams to explain the respective functions of the server and the client, but the configurations of the printer drivers are actually the same.

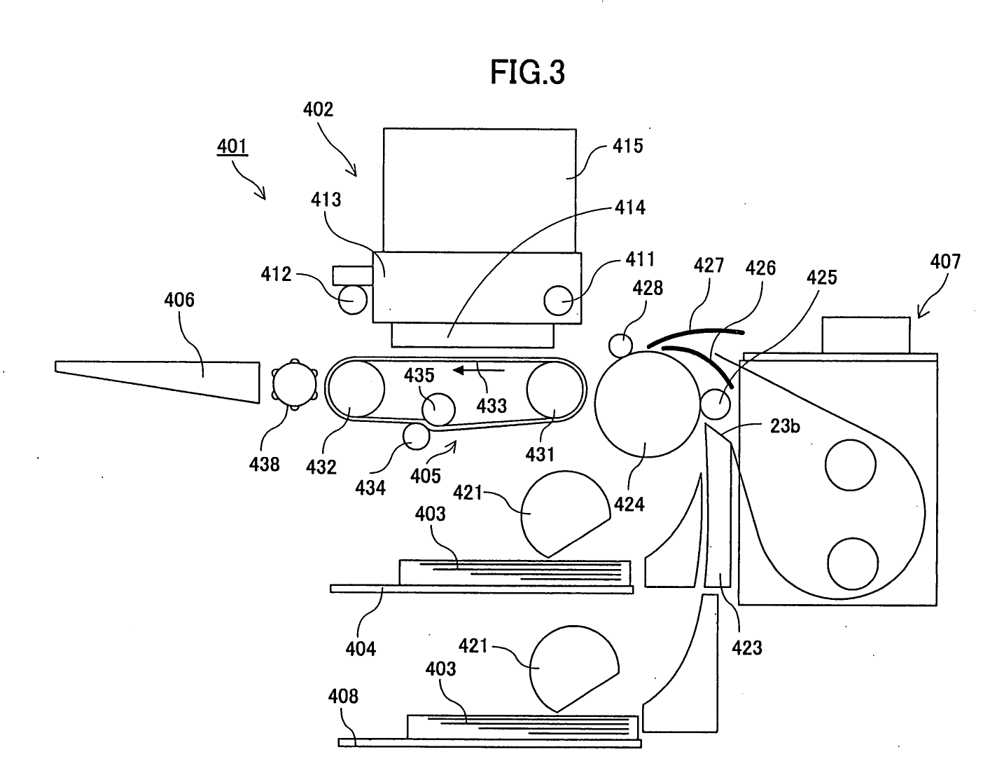

Next, with reference to FIG. 3, a brief description is given of an example of a printer where a perfecting unit and an expansion tray can be used as an option.

The printer includes a main body 401, a picture forming part 402 in the main body 401, a plurality of recording media 403 (hereinafter, referred to as Paper 403) beneath the main body 401, and a paper supplying cassette 404 whereon Paper 403 can be mounted. The paper 403 is supplied by a transport mechanism 405 to the picture forming part 402. The picture forming part 402 prints out the required picture on Paper 403 while Paper 403 is carried by the transport mechanism 405. Then, Paper 403 is delivered to a delivery tray 406 mounted on the lateral side of the main body 401.

Moreover, a detachable perfecting unit 407 can be mounted on the main body 401 as an option. To perform a perfecting printing, after one side (face) of Paper 403 is printed, Paper 403 is carried by the transport mechanism 405 in the reverse direction into the perfecting unit 407. Then, Paper 403 is turned over and carried to the transport mechanism 405 again so that the other side (backside) can be printed. After the other side (backside) is printed, then Paper 403 is delivered to the delivery tray 406.

Furthermore, a detachable expansion cassette 408 can be set under the paper supplying cassette 404, and thereby, Paper 403 can be supplied from the expansion cassette 408.

Here, the picture forming part 402 includes guide shafts 411, 412, and a carriage 413 which can be moved by sliding. The carriage 413 is moved (main scanning) by a main scanning motor in a direction perpendicular to the direction in which Paper 403 is delivered. The carriage 413 includes a recording head 414 which is a droplet discharging head where a plurality of nozzle holes is arranged to work as exhaust slots for discharging droplets. Further, the carriage 413 includes a detachable ink cartridge supplying the liquid to the recording head 414.

Further, the paper supplying cassette 404 and the expansion cassette 408 separate a piece of paper from Paper 403 and supplying the paper one by one to the main body 401 by paper supply roller (a half moon roller) 421 and by a separating pad where a drawing is omitted. Then, Paper 403 is carried to the transport mechanism 405.

The transport mechanism 405 includes a guide for guiding Paper 403 to the upper side, a transport guide part 423 guiding Paper 403 sent from the perfecting unit 407, a transporting roller 424 transporting Paper 403, a guide member 426 guiding Paper 403 to the transporting roller 424, a pressure roller 425 pressing Paper 403 on the transporting roller 424, and another guide member 427 guiding Paper 403 returned when performing a perfecting printing with the perfecting unit 407 and another pressure roller 428 pressing Paper 403 so as to transport Paper 403 from the paper transporting roller 424.

Moreover, the transport mechanism 405 includes a transport belt 433 stretched around a driving roller 431 and a subordinate roller 432, an electrification roller 434 electrifying the transport belt 433, and a guide roller 435 opposing the electrification roller 434 so as to transport Paper 403 by the recording head 414 keeping Paper 403 flat.

Furthermore, in the downstream of the transport mechanism 405, a delivery roller 438 is provided for delivering Paper 403 whereon a picture is printed to the delivery tray 406.

Accordingly, in the above described printer, the perfecting unit 407 and the expansion cassette 408 are used as an option, the computers (Server PC 1 and Client PC 2) using the printer on the host side obtain information regarding whether such an option is mounted so as to instruct the perfecting print and to select a supplying means and a size of the paper to be supplied.

Since Server PC 1 is connected to the printer 4, the status information of the printer 4 including the option information can be obtained by the port monitor 13 of the printer driver 10. Therefore, information regarding whether the perfecting is in the print property and information on selecting the paper supplying cassette to be used can be displayed.

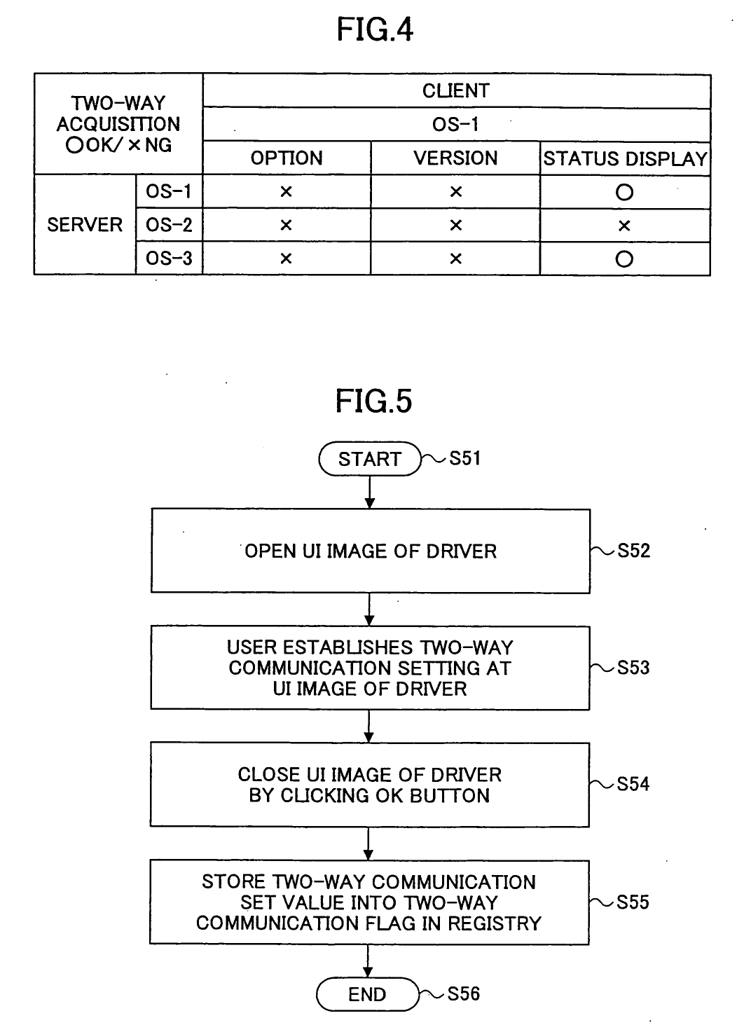

In a case where Client PC 2 has no printer driver according to the present invention, two-way communication with Server PC 1 depends on the OS of Client PC 2. As a result, the two-way communication is denied by the OS of Client PC 2, and thereby, Client PC 2, for example as shown in FIG. 4, may fail to obtain the option information, the version information, and the status displaying information (X as shown in FIG. 4). It should be noted that OS-1, OS-2 and OS-3 shown in FIG. 4 are respectively different OSs.

On the contrary, in Client PC 2 having a printer driver 20 according to the present invention, the printer driver 20 does not depend on the OS of Client PC 2, and accordingly, the status information can be obtained from Server PC 1 by enabling two-way communication regardless of the OS of Client PC 2.

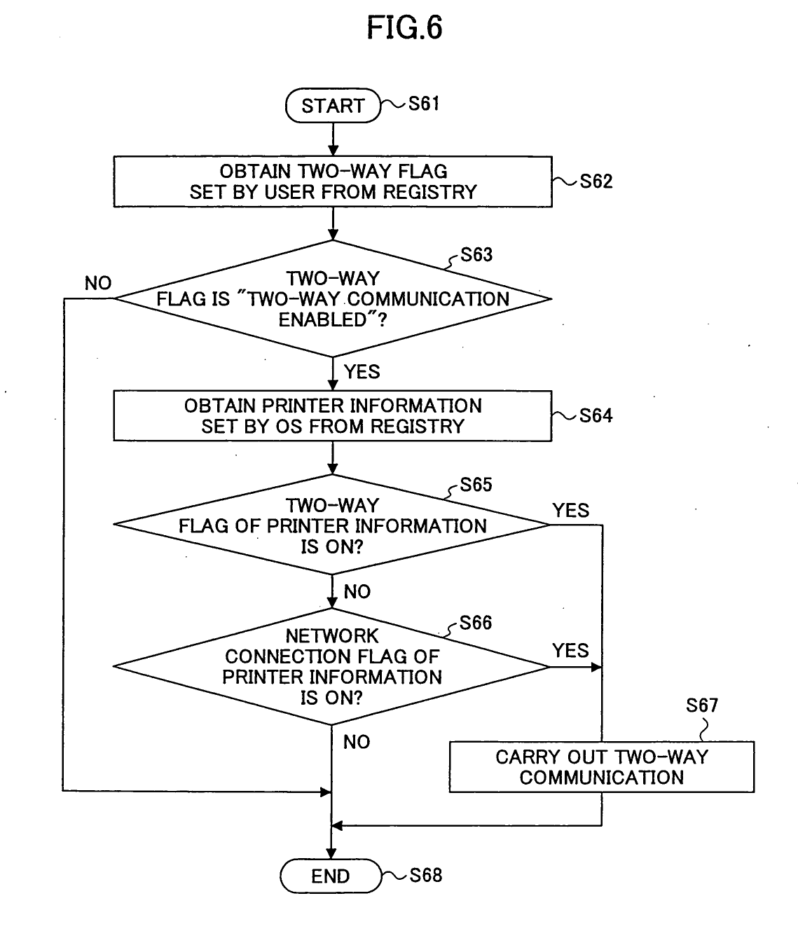

A description is given of the process with reference to FIGS. 5 and 6.

First, according to the present embodiment, a two-way communication flag setting operation is performed as shown in FIG. 5 so that a user can set ON/OFF the two-way communication operation. Accordingly, the user opens a UI (user interface) of the printer driver (S52), then clicks an “OK” button so as to close the UI (S54) after setting two-way communication in the UI of the printer driver (S53). Thus, the printer driver stores a value of the two-way communication setting in the two-way communication flag of a registry (S55) (for example, DEVMODE).

When the setting screen (the print property) of the printer driver 20 is opened by the instruction of printing from the application software, a two-way communication executing operation shown in FIG. 6 is started. Then, the two-way communication flag which is set by the user is obtained from the registry (S62) (for example, DEVMODE), and it is determined whether the two-way communication flag is in a state of “The two-way communication is enabled” (S63). If it is determined that “The two-way communication is enabled”, printer information (bit configuration) set by the OS is obtained from the registry (S64).

After the printer information is obtained, it is determined whether the two-way communication flag of the printer information is ON (S65). If the two-way communication flag is ON, the two-way communication is executed (S67). If the two-way communication flag is not ON, it is determined whether a network connection flag of the printer information is ON (S66). If the network connection flag is ON, the two-way communication is executed.

It should be noted that the status display utility 24 is run by starting a printout, and hereafter, the status display utility 24 performs a two-way communication so as to obtain the status information of the printer 4.

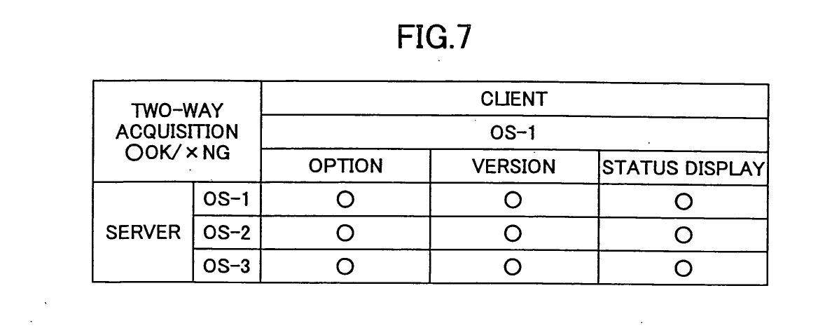

Accordingly, in a case where a two-way communication with Server PC 1 is denied by the OS of Client PC 2, for example as shown in FIG. 7, Client PC 2 can obtain the option information, the version information, and the status displaying information of the printer 4.

Therefore, the printer diver is applicable to a system in which a server computer is connected to a client computer via a network, and the server computer and the client computer can share a printer connected to the server computer. Since the printer driver obtains the status information of the printer by performing two-way communication with the server computer regardless of the operating system of the client computer, with a simple configuration, the status information of the printer connected to the server computer can be obtained even if the two-way communication is denied on the OS side.

In addition to the printer driver, the information processing device can obtain the status information of the printer connected to the server computer by executing a program realizing the above described function of the printer driver even if the information processing device is used as a client computer and the two-way communication can not be performed because of the differences of the OSs of the server computer and the client computer.

It should be noted that the description of the present invention is given with an example of an ink jet recording device, but an electrophotographic printer can also used as the printer of the present invention. Further a complex machine where a printer, a fax machine and a copier are unified can also be applied to the present invention.

The present application is based on Japanese priority application No. 2004-259105 filed on Sep. 16, 2004, with the Japanese Patent Office, the entire contents of which are hereby incorporated by reference.

1. A method for obtaining a status, wherein
a server computer and a client computer connected to a network share a printer connected to said server computer, and
said client computer enables two-way communication and obtains status information of the printer via the server computer without depending on an operating system.

2. The method for obtaining the status information as claimed in claim 1, wherein
said status information to be obtained is at least one of option information indicating whether a mountable option is mounted on said printer, version information regarding a version of said printer, and status displaying information regarding a status of said printer.

3. A printer driver applicable to a system in which a server computer and a client computer connected to a network share a printer connected to said server computer, comprising:
a unit to obtain status information of said printer by performing two-way communication with said server computer without depending on an operating system of said client computer.

4. The printer driver as claimed in claim 3, further comprising:
a unit to perform the two-way communication by using a language monitor of said server computer as a server; and
a unit to make said two-way communication means to perform the two-way communication without depending on an operating system.

5. The printer driver as claimed in claim 3, wherein the status information to be obtained by said printer driver is at least one of option information indicating whether a mountable option is mounted on said printer, version information regarding a version of said printer, and status displaying information regarding a status of said printer.

6. An information processing device applicable to a system in which a server computer and a client computer connected to a network share a printer connected to said server computer, comprising:
a unit to obtain status information of said printer by performing two-way communication with said server computer without depending on an operating system of said information processing device.

7. The information processing device as claimed in claim 6, further comprising:
a unit to perform a two-way communication by using a language monitor of said server computer as a server; and
a unit to make said two-way communication means to perform the two-way communication without depending on an operating system of said information processing device.

8. The information processing device as claimed in claim 6, wherein the status information to be obtained is at least one of option information indicating whether a mountable option is mounted on said printer, version information regarding a version of said printer, and status displaying information regarding a status of said printer.

9. The information processing device as claimed in claim 7, wherein the status information to be obtained is at least one of option information indicating whether a mountable option is mounted on said printer, version information regarding a version of said printer, and status displaying information regarding a status of said printer.

10. The printer driver as claimed in claim 4, wherein the status information to be obtained by said printer driver is at least one of option information indicating whether a mountable option is mounted on said printer, version information regarding a version of said printer, and status displaying information regarding a status of said printer.
